(19) United States
(12) Patent Application Publication
(10) Pub. No.: US 2005/0237439 A1
(43) Pub. Date: Oct. 27, 2005

(54) Touch panel

(75) Inventor: Che-Kuei Mai, Hsinchu City (TW)

Correspondence Address: LIU & LIU, 444 S. FLOWER STREET SUITE 1750, LOS ANGELES, CA, 90071, US

(73) Assignee: Toppoly Optoelectronics Corp.

(21) Appl. No.: 10/830,206

(22) Filed: Apr. 21, 2004

(51) Int. Cl. G02F 1/1335

(52) U.S. Cl. 349/12

(57) ABSTRACT

A touch panel. A top transparent substrate includes a top conductive film on its lower surface. A bottom transparent substrate includes a bottom conductive film on its upper surface. An insulating spacer is located between the two conductive films to separate the top conductive film and the bottom conductive film. A plurality of sensing lines, are each disposed on an edge of the top or bottom conductive film and separated from other conductive films or other sensing lines by an adhesive. At least one grounding loop isolated from the top and bottom conductive films by an insulating region, wherein the grounding loop is electrically coupled to an external ground terminal.

### BACKGROUND OF THE INVENTION

1. Field of the Invention

The present invention relates to a touch panel, and more particularly, relates to a touch panel providing electrostatic discharge (ESD) protection.

2. Description of the Related Art

FIG. 1 is a front view showing a conventional four-line touch panel. FIG. 2 is a cross section taken along line A-A′ of FIG. 1. Referring to FIGS. 1 and 2, the touch panel 101 includes a top transparent substrate 100, a bottom transparent substrate 200, and insulating spacers 600. An ITO (indium tin oxide) film 120 is coated on the lower surface of the top transparent substrate 100, and an ITO film 220 is coated on the upper surface of the bottom transparent substrate 200. The insulating spacer 600 is disposed between the ITO film 120 of the top transparent substrate 100 and the ITO film 220 of the bottom transparent substrate 200 to separate the two ITO films.

An adhesive (such as a double-side adhesive) 500 is disposed between the edges of the top and bottom ITO films 120 and 220, in order to separate the sensing line from another ITO film or from another sensing line. The areas on the edges of the panel where signal lines are located are labeled “S”. The area outside of the sensing line area is an active area (AA).

External power is supplied to the touch panel 101. When the top transparent substrate 100 is contacted by, for example, a finger or stylus, electric contact occurs between the two ITO films 120 and 220. The relative change in voltage and/or current arising from such contact creates a signal that is sensed by the sensing lines 310, 320, 410 and 420, and transmitted via transmission lines 310a, 320a, 410a and 420a.

FIG. 3 shows a conventional display system 110 with a touch panel. As shown in FIG. 3, controller 103 computes the analog signal S1 transmitted from touch panel 101 to obtain the relative position of the contact point with respect to the active are AA, and the CPU 105 makes appropriate responses at the corresponding position on the LCD panel according to the obtained relative position. However, during operation of the display system, the electric elements in the controller 103 may burn out from electrostatic discharge through the touch panel 101.

### SUMMARY OF THE INVENTION

It is therefore an object of the present invention to prevent burnout in the controller from electrostatic discharge (ESD) through the touch panel.

According to the preceding object, the present invention provides a touch panel providing ESD protection. The touch panel is grounded to prevent electrostatic charges from reaching the sensing lines, transmission lines, and/or control electronics. A grounding conductor is attached to the touch panel.

In one embodiment of the touch panel of the present invention, a top transparent substrate includes a top conductive film on its lower surface. A bottom transparent substrate includes a bottom conductive film on its upper surface. An insulating spacer is located between the top conductive film and the bottom conductive film. Each of a plurality of sensing lines, is disposed on an edge of the top or bottom conductive film and separated from other conductive films or sensing lines by an adhesive. At least one grounding loop is isolated from the top conductive film and the bottom conductive film by an insulating region. The grounding loop is electrically coupled to an external ground terminal, thereby dissipating the electrostatic discharge.

### BRIEF DESCRIPTION OF THE DRAWINGS

The present invention can be more fully understood by the subsequent detailed description and examples with reference made to the accompanying drawings, wherein:

FIG. 1 is a front view showing a conventional four-line touch panel;

FIG. 2 is a cross section taken along line A-A′ of FIG. 1;

FIG. 3 shows a conventional display system with a touch panel;

FIG. 4 is a front view showing a four-line touch panel according to one embodiment of the present invention;

FIG. 5 is a cross section taken along line A-A′ of FIG. 4.

FIG. 6 is a schematic diagram of a display system with a touch panel of the present invention.

FIG. 7 is a schematic diagram of an electronic device having a display with a touch panel of the present invention.

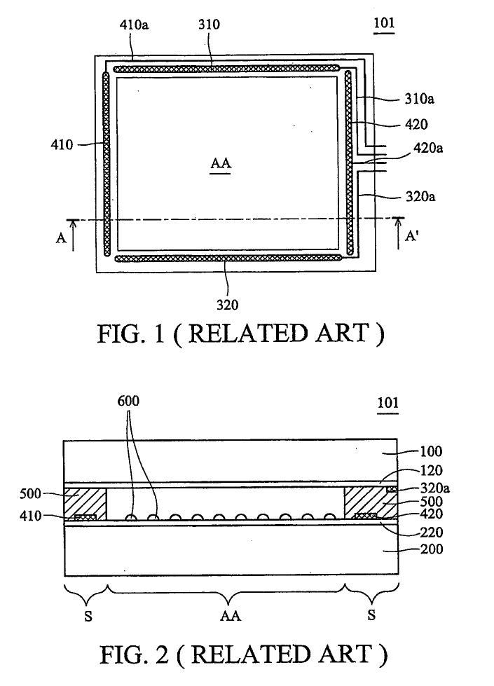

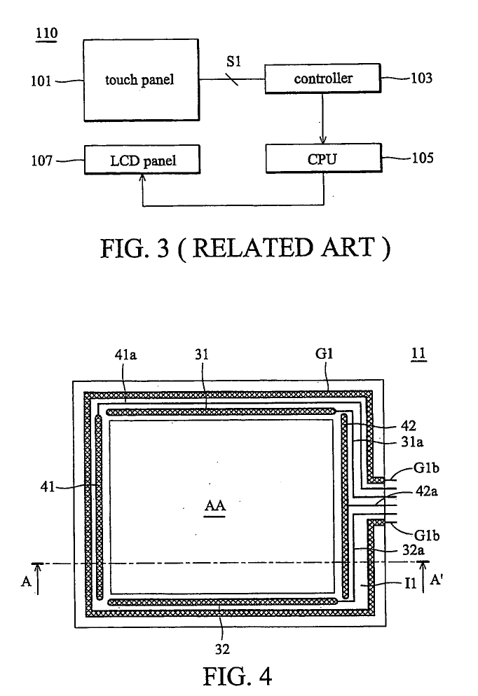

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

It is noted that the description hereinbelow refers to various layers arranged on, above or overlying other layers, to describe the relative positions of the various layers. References to “on”, “above”, “overlying”, or other similar languages, are not limited to the interpretation of one layer being immediately adjacent another layer. There may be intermediate or interposing layers, coatings, or other structures present, and associated process steps present, which are not shown or discussed herein, but could be included to accomplish the intended purpose without departing from the scope and spirit of the invention disclosed herein. Similar, references to structures adjacent, between or other positional references to other structures merely describe the relative positions of the structures, with or without intermediate structures.

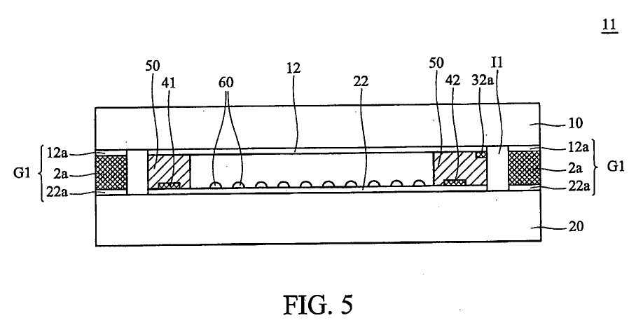

FIG. 4 is a front view showing a four-line touch panel according to one embodiment of the present invention. FIG. 5 is a cross section taken along line A-A′ of FIG. 4. Referring to FIGS. 4 and 5, the touch panel 11 of the present invention has a contact sensitive panel comprising a top transparent substrate 10, a bottom transparent substrate 20, insulating spacers 60, and a plurality of sensing lines 31, 32, 41 and 42. The contact sensitive panel is grounded using a grounding loop G1. The top and bottom transparent substrates can be glass or plastic. For example, the top and bottom transparent substrates 10 and 20 can be polyester plastic, with PET (polyethylene terephthalate) being a representative example. Preferably, the top transparent substrate is flexible plastic suitable for frequent contact. While FIGS. 4 and 5 describe a contact sensitive panel with a specific structure, it can be appreciated that other structures can also be employed as long as the sensitive panel is a panel that responds to extend stimulus in the form of physical contact with the panel.

The top substrate 10 is provided with a conductive bottom surface. As shown in the illustrated embodiment, a top conductive film 12 is coated on the entire lower surface of the top transparent substrate 10. The bottom substrate 20 is provided with a conductive top surface. As shown in the illustrated embodiment, a bottom conductive film 22 is coated on the entire upper surface of the bottom transparent substrate 20. The top and bottom conductive films 12 and 22 act as resistive layers and can be ITO (indium tin oxide), tin layer, ATO (antimony-tin-oxide) or the like. The insulating spacer 60 is disposed between the top conductive film 12 of the top transparent substrate 10 and the bottom conductive film 22 of the bottom transparent substrate 20 for separation thereof.

The sensing lines 31, 32, 41 and 42 can be metal lines such as silver lines and can include four sensing lines, two top sensing lines 31 and 32 disposed on the two opposite edges of the top conductive film 12, and two bottom sensing lines 41 and 42 disposed on the opposite edges of the bottom conductive film 22. The bottom sensing lines 41 and 42 are arranged at a right angle to the top sensing lines 31 and 32. The sensing lines can further include four transmission lines 31a, 32a, 41a and 42a respectively. A spacer made of an insulating material, for example an adhesive (such as a double-side adhesive) 50 is disposed between the edges of the top and bottom conductive films 12 and 22, to separate the conductive elements (e.g., contuctive film 12, sensing line 31 and 32) on the substrate 12 from the conductive elements (e.g., conductive film 22 and sensing line 41 and 42) on the substrate 22.

A grounding conductor, such as a grounding loop is provided to surround the sensing lines 31, 32, 41 and 42 (i.e., outside the active area of the touch panel. An insulating region I1 is disposed between the top and bottom transparent substrates 10 and 20, to separate the grounding loop G1 from the conductive films 12 and 22, or from the sensing lines 31, 32, 41 and 42. The grounding loop G1 is connected to an external ground terminal (not shown in FIG. 5) by a grounding line G1b. For example, the external ground terminal can be a chassis ground or a ground terminal of a touch panel controller, of a LCD panel display, or an electric apparatus.

In addition, in this case, the grounding loop G1 can be a conductive stacked film as shown in FIG. 5. The grounding loop G1 includes a first conductive film 12a, a second conductive film 2a and a third conductive film 22a. The first conductive film 12a and the third conductive film 22a can be made of ITO, tin oxide or antimony-tin-oxide (ATO). The first conductive film 12a and the top conductive film 12 can be formed, for example, on the lower surface of the top transparent substrate 10 at the same time. The third conductive film 22a and the bottom conductive film 22 can be formed on the upper surface of the bottom transparent substrate 20 at the same time. In this case, the second conductive film 2a can be a metal film, such as a silver film, having a thickness as the thickness of the spacer 50. While FIG. 5 shows a three-layer structure for the grounding loop G1, it can take the form of a single layer conductive structure having a thickness extending from the bottom of substrate 10 to the top of substrate 20, without departing from the scope and spirit of the present invention.

The second conductive film 2a need not extend completely along the loop G1, and may be omitted completely as long as the first and third conductive films 12 and 22 are conductively coupled. For example, the second conductive film 2a may be replaced by a non-conductive layer, or the first and third conductive films 12 and 22 may be spaced apart by air, but the first and third conductive films 12 and 22 are otherwise conductively coupled to each other, or they are separately conductively coupled to the external ground.

In the embodiment of the present invention shown in the figures, the grounding loop G1 is physically and electrically separated from the conductive films 12 and 22, and the sensing lines 31, 32, 41 and 42 by the insulating region I1. In this embodiment, to electrically insulate from conductive films 12 and 22 and the sensing lines 31, 32, 41 and 42, the insulating region I1 can be made of an insulating material, such as SiO₂, or the insulating region I1 can be an air space or a space filled with gas.

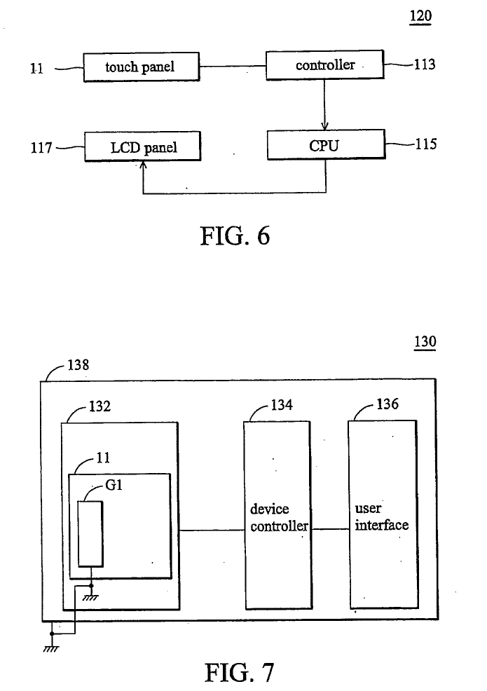

As shown in FIG. 6, in the display system 120, a display element such as an LCD element 117 is operatively coupled to the touch panel 11, wherein locations on an active area of the contact sensitive panel correspond to locations on a display area of the display element. When the top transparent substrate 10 is contacted by, for example, a finger or stylus, electric contact occurs between the two conductive films 12 and 22. The sensing lines 31, 32, 41 and 42 transmit current and/or voltage signals to a touch panel controller 113 (see FIG. 6) via signal transmission lines 31a, 32a, 41a and 42a. The touch contact location can be determined from such signals using conventional schemes well known in the art.

Because of the grounding loop, a display system with touch panel can dissipate ESD charges from the touch panel to an external grounding terminal, such as that of a plate display or an electric apparatus, protecting the electric elements in the touch panel controller from ESD damage.

Although a four-line panel is taken as an example in the above descriptions, the present invention also suitable for use in five-line, six-line or eight-line type touch panels.

In the embodiment of the present invention shown, the grounding loop surrounds the sensing lines, is electrically insulated therefrom and from the top and bottom transparent substrates, and is electrically coupled to an external grounding terminal. Accordingly, the electric elements in the touch panel controller are protected from ESD damage.

FIG. 7 schematically shows an electronic device 130 deploying a display system 132 having the touch panel 11 described above. The electronic device 130 may be a portable device such as a PDA, notebook computer, tablet computer, cellular phone, or a display monitor device, etc. Generally, then electronic device 130 includes a housing 138, the display system 132 having the touch panel 11, device controller 134, user interface 136, etc. The grounding conductor (i.e., grounding loop G1) is coupled to the chassis ground of the electronic device 130.

Further, the touch panel in accordance with the present invention may be deployed in electronic devices as an user input device, not as an integral part of a display systems. For example, the inventive touch panel may be deployed in electronic devices, as standalone input devices, such as writing or drawing pads, tablets, boards or other types of input devices requiring a user touch or stylus input, or peripheral devices which may be a part of a larger electronic device or which may be operatively coupled to another electronic device, such as a computing device or a machine.

While the inventive touch panel is described above in connection with an LCD display system, the present invention may be deployed in other types of display systems, such as systems deploying a plasma display element, or a cathode ray tube display element.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). For example, the grounding conductor need not be configured in a closed loop as shown in FIG. 4. The grounding conductor may be configured in separate sections that are grounded, or a continuous section that is less than a complete closed loop, such as an open or partial loop, such as an U-shaped or C-shaped loop. Therefore, the scope of the appended claims should be accorded the broadest interpretation so as to encompass all such modifications and similar arrangements.

1. A touch panel input device, comprising:
a contact sensitive panel; and
a grounding conductor conductively coupled to the contact sensitive panel and configured to be conductively coupled to external ground.

2. The touch panel as claimed in claim 1, wherein the contact sensitive panel comprises a first substrate exposed to contact by a user, and wherein the grounding conductor is conductively coupled to the first substrate.

3. The touch panel as claimed in claim 2, wherein the first substrate comprises a surface exposed to contact by the user, and a first conductive surface, wherein the grounding conductor is conductively insulated from the first conductive surface.

4. The touch panel as claimed in claim 2, wherein the contact sensitive panel further comprises a second substrate electrically insulated from the first substrate, and wherein the grounding conductor is conductively coupled to the second substrate.

5. The touch panel as claimed in claim 4, wherein the second substrate comprises a second conductive surface, and wherein the grounding conductor is conductively insulated from the second conductive surface.

6. The touch panel as claimed in claim 3, wherein the contact sensitive panel further comprises a second substrate conductively insulated from the first substrate, wherein the second substrate comprises a second conductive surface facing the first conductive surface, and wherein the grounding conductor is conductively coupled to the second substrate and conductively insulated from the second conductive surface.

7. The touch panel as claimed in claim 6, wherein the grounding conductor comprises a first conductive layer on the first substrate on the same side as the first conductive surface, a second conductive layer on the second substrate on the same side as the second conductive surface, wherein the first and second conductive layers are conductively coupled.

8. The touch panel as claimed in claim 7, wherein the first and second conductive layers are formed on the first and second substrates along with the first and second conductive surfaces on the first and second substrates.

9. The touch panel as claimed in claim 7, wherein the grounding conductor comprises a generally loop shaped structure.

10. The touch panel as claimed in claim 9, wherein the loop extends along the periphery of the contact sensitive panel.

11. The touch panel as claimed in claim 1, wherein the grounding conductor comprises a generally loop shaped structure.

12. The touch panel as claimed in claim 11, wherein the generally loop shaped structure is a complete closed loop.

13. The touch panel as claimed in claim 11, wherein the loop extends along the periphery of the contact sensitive panel.

14. The touch panel as claimed in claim 1, wherein the contact sensitive panel comprises sensing lines that facilitate sensing relative changes in electrical properties arising from user contact within an active area of the contact sensitive panel covered by the sensing lines, wherein the grounding conductor is conductively coupled to the touch panel outside the active area covered by the sensing lines.

15. The touch panel as claimed in claim 1, wherein the grounding conductor comprises a first section attached to the contact sensitive panel, and a second section extending from the first section to the external ground.

16. A display system, comprising a touch panel as claimed in claim 1, and a display element operatively coupled to the touch panel, wherein locations on an active area of the contact sensitive panel correspond to locations on a display area of the display element.

17. The display system as in claim 16, wherein the display element is at least one of liquid crystal display element, plasma display element and cathode ray tube element.

18. An electronic device, comprising:
a display system as in claim 16; and
a device controller coupled to the display system and configured to process data corresponding to an image to be rendered by the display system.

19. The electronic device as claimed in claim 18, comprising at least one of a portable device, a display monitor and a user input device.
